(19) United States
(12) Patent Application Publication
(10) Pub. No.: US 2026/0138321 A1
(43) Pub. Date: May 21, 2026

(54) APPARATUS FOR DEGASSING MOLTEN PLASTIC MATERIAL

(71) Applicant: Gamma Meccanica S.p.A., Bibbiano, Frazione Ghiardo (IT)

(72) Inventor: Paolo BOVIS, Reggio Emilia (IT)

(21) Appl. No.: 19/120,942

(22) PCT Filed: Oct. 24, 2023
(86) PCT No.: PCT/IB2023/060708

§ 371 Date: Apr. 14, 2025

(30) Foreign Application Priority Data
Oct. 25, 2022 (IT) 102022000021948

(51) Int. Cl. B29C 48/76

(52) U.S. Cl. CPC B29C 48/766; B29C 48/761

(57) ABSTRACT

An apparatus for degassing molten plastic material, comprising an intake chamber, provided with an entry port and an exit port, and an evacuation chamber for a gas present in the molten plastic material, provided with an entry opening and an exit opening, and forming elements for the molten plastic material in transit through the evacuation chamber, which comprise at least one forming die, the forming elements being adapted to assume alternately a first operating configuration, in which the at least one die is associated in communication with chambers through the exit port of the intake chamber and the entry opening of the evacuation chamber, and a second operating configuration, in which the at least one die is accessible from outside the chambers.

The present application is a U.S. national stage entry under 35 U.S.C. § 371 of PCT International Patent Application No. PCT/IB2023/060708, filed Oct. 24, 2023, which in turn claims priority to Italian Patent Application No. 102022000021948, filed Oct. 25, 2022, the entirety of each of which are incorporated herein by reference.

The present invention relates to an apparatus for degassing molten plastic material.

In the sector of processing recycled plastic materials, lines are known for forming granules of material which involve, generally, a first and a second stage of extrusion, between which an apparatus is interposed for degassing the molten plastic material.

The purpose of such degassing apparatus is to eliminate, or at least considerably reduce, the bubbles of gas trapped inside the plastic material, which negatively influence the quality of the granules that it is possible to obtain.

The quantity of gas that is produced within the mass of molten plastic material in the first stage of extrusion increases as a function of the humidity of that material, the quantity of impurities contained in it, and the percentage of molding to which it has been subjected previously.

Such degassing apparatuses substantially comprise an intake chamber for the associated molten material, followed by an evacuation chamber for the gaseous component, in which a negative pressure is applied, the two chambers being in communication through a die that makes it possible to form the material entering the evacuation chamber so as to increase the exposed surface of the material in order to facilitate the egress and removal of the gaseous component.

The die is generally integrated in a plate clamped between the open top of the evacuation chamber and the open bottom of the intake chamber.

This type of degassing apparatus is described for example in U.S. Pat. Nos. 3,410,938 and 6,652,630B1 .

During use, the impurities present in the mass of molten material tend to be deposited on the openings of the die, gradually reducing the passage cross-section of the die for the material. This situation leads to an increase in the drop in pressure to which the stream of material is subjected, with a possible rise in temperature and consequent deterioration, and an increase in the internal pressure in the intake chamber with associated risk of egress of the molten material.

In order to guard against such drawbacks it is necessary to periodically intervene to clean/replace the die.

These conventional degassing apparatuses are not devoid of drawbacks, among which is the fact that interventions to clean/replace the die require the shutdown of the heating elements of the production line and lengthy interruptions to the operation of the line in order to open the intake chamber, remove the die, clean or replace it, reassemble the apparatus, and switch the heating elements back on until the operating temperature is reached.

The aim of the present invention is to eliminate the above-mentioned drawbacks in the background art by providing an apparatus for degassing molten plastic material that makes it possible to considerably reduce the time to execute maintenance interventions on the die, in so doing limiting the impact on the running costs of the production line.

Within this aim, an object of the present invention is to devise an apparatus that does not require the shutdown of the heating elements of the production line in order to execute cleaning/replacement interventions on the die when the line is cold.

Another object of the present invention is to devise an apparatus that enables a more frequent execution of cleaning/replacement interventions on the die, for the purpose of increasing the overall efficiency of the production line.

Another object of the present invention is to provide an apparatus that is simple, easy and practical to implement, safe in use, effective in operation, and at low cost.

This aim and these and other objects that will become more apparent hereinafter are achieved by the present apparatus for degassing molten plastic material according to claim 1, and optionally provided with one or more of the characteristics recited in the dependent claims.

Further characteristics and advantages of the present invention will become more apparent from the detailed description of a preferred, but not exclusive, embodiment of an apparatus per degassing molten plastic material, which is illustrated for the purposes of non-limiting example in the accompanying drawings wherein:

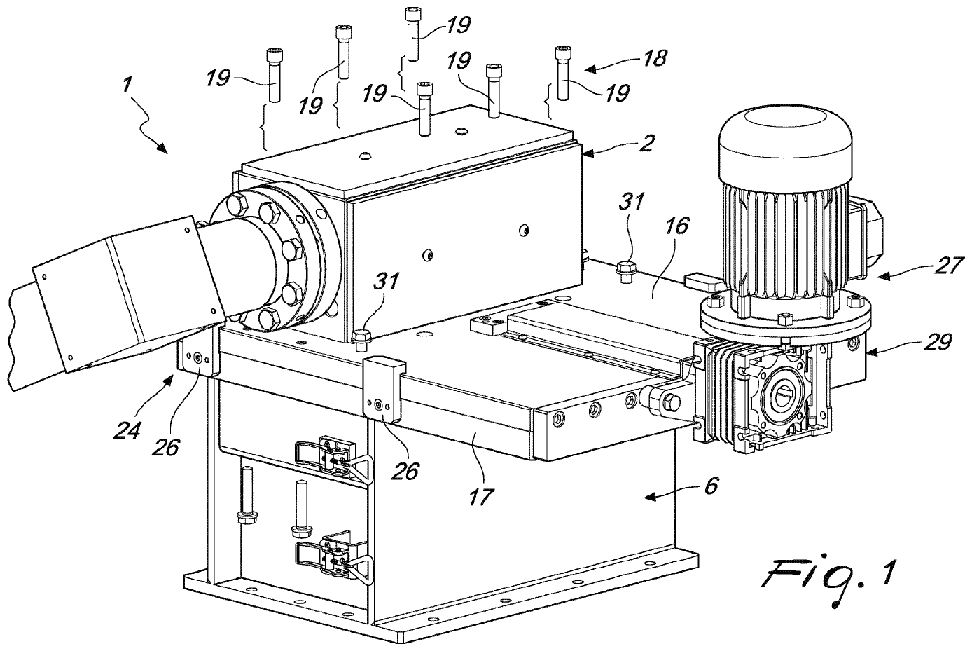

FIG. 1 is a perspective view from the rear of the apparatus for degassing molten plastic material, according to the invention, with the forming means in the first operating configuration and the locking screws extracted from their seats;

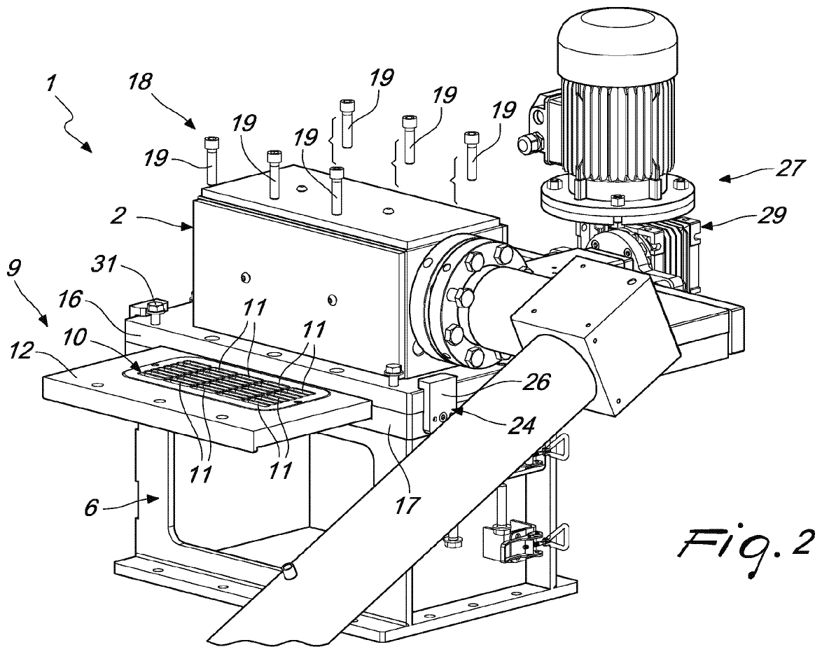

FIG. 2 is a front perspective view of the apparatus according to the invention, with the forming means in the second operating configuration and the locking screws extracted from their seats;

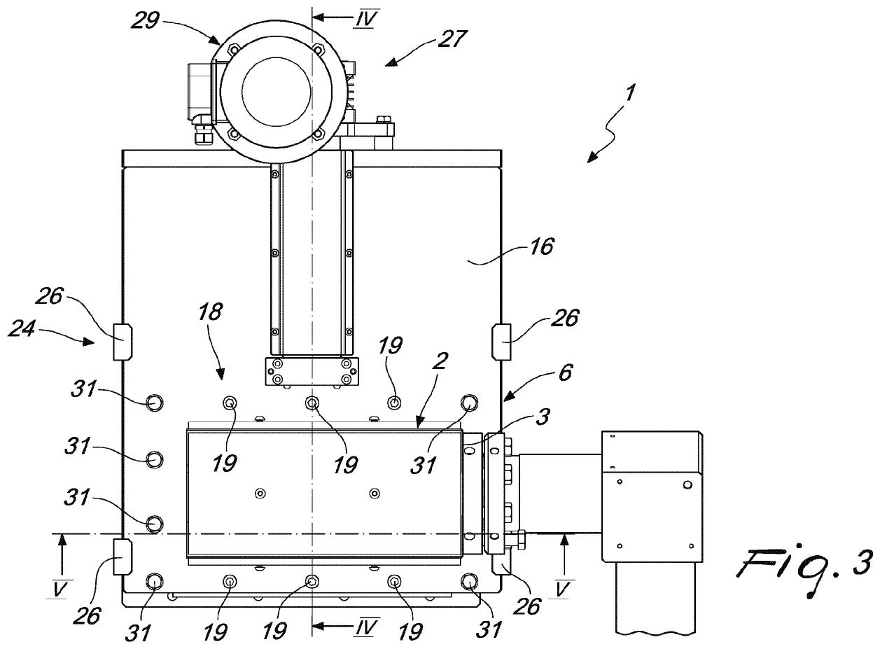

FIG. 3 is a plan view of the apparatus according to the invention, with the forming die in the first operating configuration;

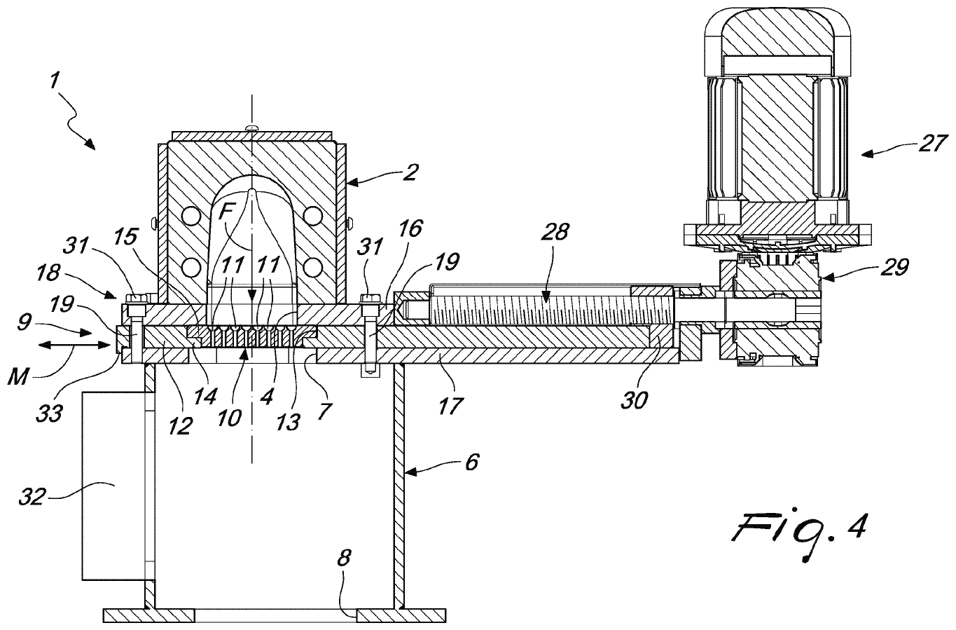

FIG. 4 is a cross-sectional view taken along the line IV-IV in FIG. 3;

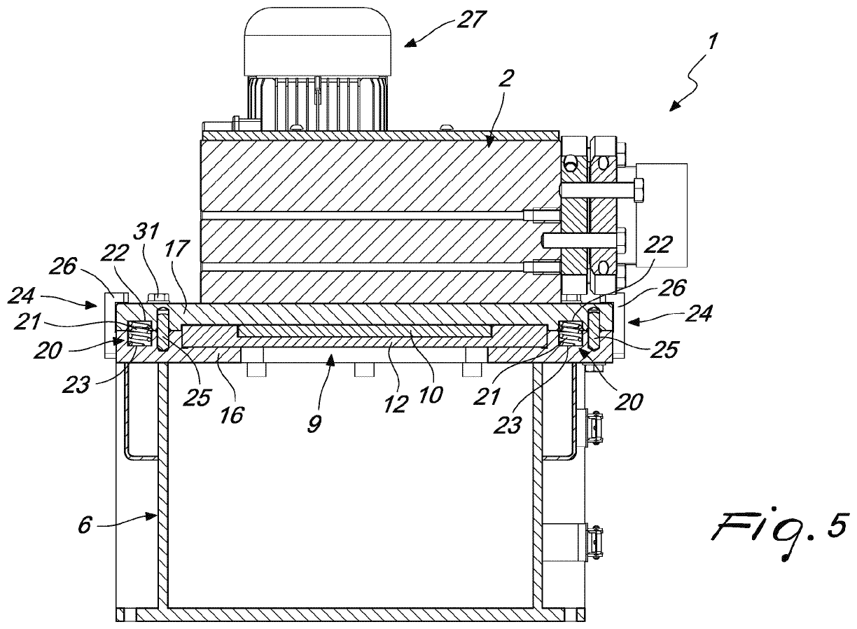

FIG. 5 is a cross-sectional view taken along the line V-V in FIG. 3;

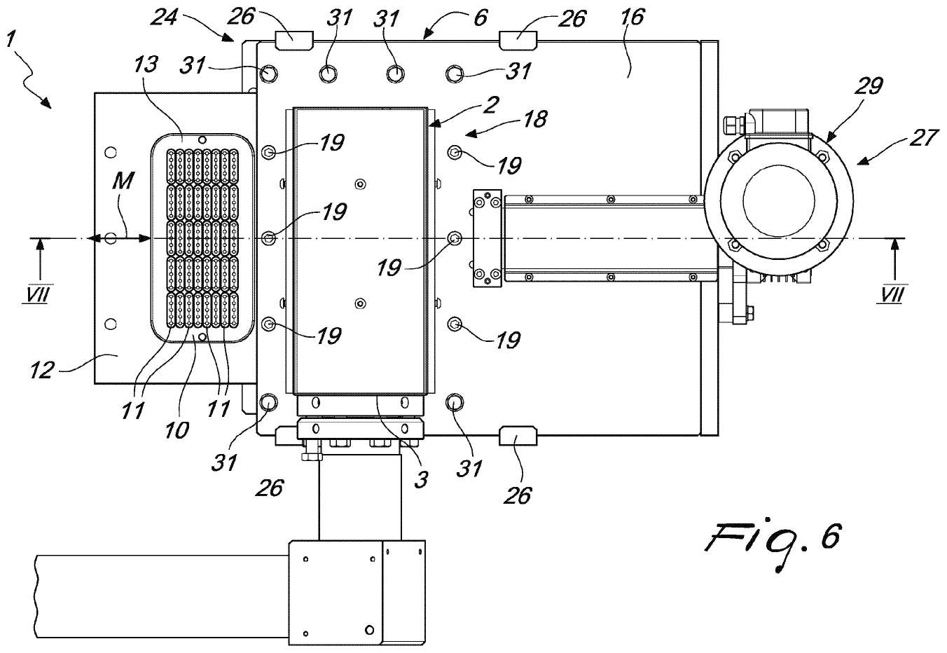

FIG. 6 is a plan view of the apparatus according to the invention, with the die in the second operating configuration;

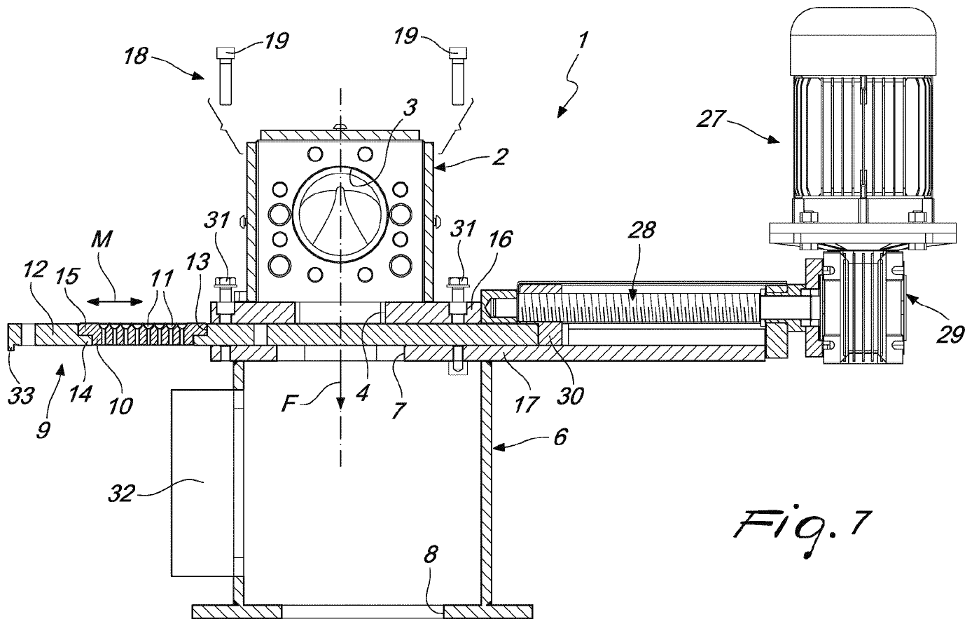

FIG. 7 is a cross-sectional view taken along the line VII-VII of FIG. 6;

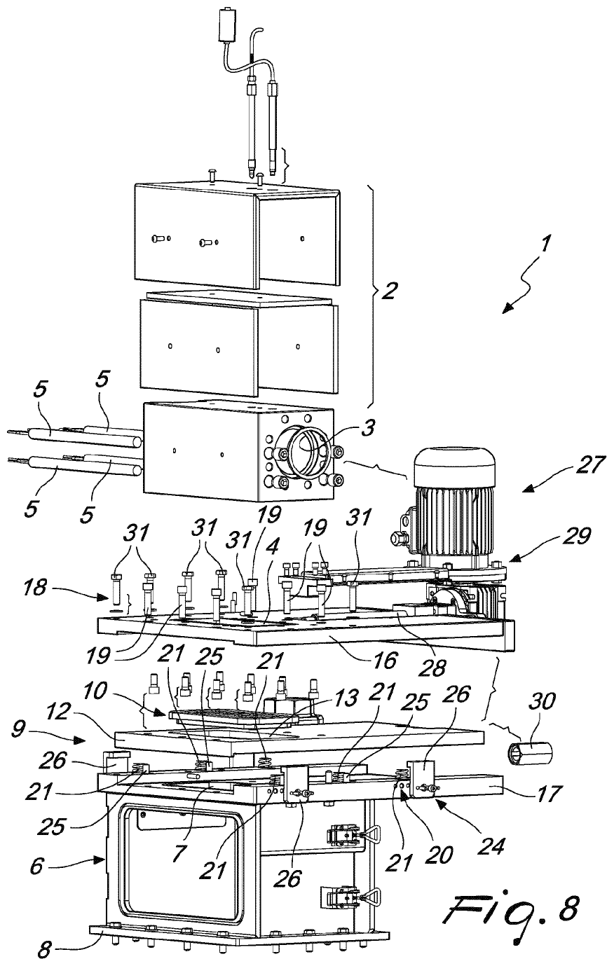

FIG. 8 is an exploded perspective view of the apparatus according to the invention.

With reference to the figures, the reference numeral 1 generally designates an apparatus for degassing molten plastic material.

The apparatus 1 comprises an intake chamber 2 which is provided with an entry port 3 and an exit port 4 for the molten plastic material.

In use, the entry port 3 of the intake chamber 2 is typically connected to a first heated extrusion device with an optional conventional filter, not further explained, for the advancement of the molten plastic material.

The entry port 3 is generally arranged at a side face of the intake chamber 2. The exit port 4 is preferably arranged at the bottom of the intake chamber 2. In the intake chamber 2, the molten plastic material spreads out so as to flow uniformly through the exit port 4 with a flow rate that is independent of the flow rate at which it enters through the entry port 3.

The walls of the intake chamber 2 are associated with conventional heating elements 5 which are accommodated inside them.

The apparatus 1 comprises an evacuation chamber 6 for the gas present in the molten plastic material, which is provided with an entry opening 7 and with an exit opening 8 for the material. The evacuation chamber 6 is arranged downstream of the intake chamber 2 along a flow direction F of the molten plastic material through these chambers. The entry opening 7 of the evacuation chamber 6 is associated in communication with the exit port 4 of the intake chamber 2.

In use, the exit opening 8 of the evacuation chamber 6 is typically connected to a second conventional heated extrusion device, not further shown, in order to remove the molten plastic material after the degassing treatment.

### The Entry Opening 7 Is Generally Arranged on the Top of the Evacuation chamber 6. The exit opening 8 is generally arranged at the bottom of the evacuation chamber 6.

The evacuation chamber 6 is functionally associated with conventional means for creating a negative pressure 32 inside it, not further explained, for extracting and removing the gas trapped in the molten plastic material.

The flow direction F is preferably substantially vertical, so as to also take advantage of the action of the weight of the molten plastic material in transit from the intake chamber 2 to the evacuation chamber 6.

In the present description the term “substantially” means “except for the usual machining tolerances and tolerances in the assembly of the component parts”.

The apparatus 1 also comprises forming means 9 for the molten plastic material in transit from the intake chamber 2 to the evacuation chamber 6, which comprise at least one forming die 10 for the molten plastic material. The die 10 is provided with one or, more preferably, with a plurality of passage openings 11 for the molten plastic material of which the shape, dimensions and distribution are controlled as a function of the shape structure of the material in transit through the evacuation chamber 6 that it is desired to obtain.

The forming means 9 make it possible to section and shape the molten plastic material entering the evacuation chamber 6 in order to extend its exposed surface and increase the amount of gas sucked away, in so doing optimizing the effectiveness of the degassing treatment.

The forming means 9 are associated with the intake chamber 2 and evacuation chamber 6 so that they can move with an alternating sliding motion along a movement direction M transverse to the flow direction F between a first operating configuration (FIGS. 3-5) in which the passage openings 11 of the die 10 are associated in communication with said chambers through the exit port 4 of the intake chamber 2 and the entry opening 7 of the evacuation chamber 6, and a second operating configuration (FIGS. 2, 6, 7) in which the die 10 is accessible from outside the chambers.

More precisely, in the first operating configuration the die 11 is interposed between the exit port 4 of the intake chamber 2 and the entry opening 7 of the evacuation chamber 6.

Preferably the movement direction M is substantially horizontal.

Usefully the forming means 9 comprise a supporting table 12 for the at least one die 10 which is interposed between the intake chamber 2 and the evacuation chamber 6.

The supporting table 12 comprises at least one receptacle 13 for a corresponding die 10.

In the embodiment shown, the forming means 9 comprise a single die 10 and, as a consequence, the supporting table 12 is provided with a single receptacle 13. The possibility is not ruled out, however, that the forming means 9 can have a plurality of dies distributed on a plane transverse to the flow direction F. In this case the supporting table 12 should have a plurality of receptacles, one for each die.

Advantageously the receptacle 13 has a perimeter raised portion 14 which protrudes inside it. The raised portion 14 can extend along the perimeter of the receptacle 13 continuously or it can be constituted by a plurality of protruding elements distributed along said perimeter. Likewise the die 10 comprises a perimeter edge 15 which is adapted to come into abutment on the raised portion 14. The edge 15 can extend along the perimeter of the die 10 continuously or it can be constituted by a plurality of protruding elements distributed along said perimeter.

Usefully the die 10 has a thickness that is substantially similar to that of the supporting table 12, so as not to obstruct movement between the operating configurations.

The apparatus 1 further comprises a first delimiting plate 16 for the intake chamber 2 which is associated with the exit port 4 and a second delimiting plate 17 for the evacuation chamber 6 which is associated with the entry opening 7.

Preferably the first delimiting plate 16 constitutes the bottom of the intake chamber 2. The exit port 4 is directly defined on the first delimiting plate 16.

Preferably the second delimiting plate 17 constitutes the top of the evacuation chamber 6. The entry opening 7 is defined directly on the second delimiting plate 17.

The delimiting plates 16 and 17 are substantially horizontal and are spaced apart so as to interpose the supporting table 12.

Preferably the die 10 has a slightly greater thickness (in the order of a few tenths of a millimeter) than the thickness of the supporting table 12 so as to ensure adhesion between the die and the delimiting plates 16 and 17, so preventing the seepage of molten plastic material or its stagnation in any gaps.

Furthermore the apparatus 1 has reversible clamping means 18 of the supporting table 12 between the delimiting plates 16 and 17 which are adapted to assume alternately a configuration of locking the sliding of the supporting table 12 with respect to the plates and a configuration of releasing the sliding of said table.

Such reversible clamping means 18 comprise a plurality of threaded elements 19 inserted so as to pass through the supporting table 12 and the delimiting plates 16 and 17. The threaded elements 19 are preferably distributed outside the perimeter of the intake chamber 2. Each threaded element 19 has a shank inserted to pass through the first delimiting plate 16 and the supporting table 12 with the end engaged in a corresponding hole defined in the second delimiting plate 17 and a head abutting in an upper region against the first delimiting plate 16.

In the locked configuration the clamping elements 19 prevent any accidental movement of the forming means 9 from the first operating configuration.

Preferably the reversible clamping means 18 also have a plurality of safety screws 31 interposed between the delimiting plates 16 and 17. In the released configuration, such safety screws 31 must be loosened so as to release the delimiting plates 16 and 17 before actuating the movement of the forming means 9 between the first and the second operating configuration.

The apparatus 1 comprises elastic compression means 20 interposed between the delimiting plates 16 and 17 for spacing said plates apart when the reversible clamping means 18 assume the release configuration.

Such elastic compression means 20 comprise a plurality of elastic compression elements 21, such as helical springs or the like, distributed between the delimiting plates 16 and 17 and accommodated in corresponding niches 22 and 23 which face toward and are defined on the plates proper.

When the reversible clamping means 18 assume the locked configuration, the springs 21 are compressed between the delimiting plates 16 and 17 within the respective niches 22 and 23. When the reversible clamping means 18 assume the released configuration, the springs 21 extend so as to lift the first delimiting plate 16 and favor the sliding of the supporting table 12.

The apparatus 1 further comprises guiding means 24 for moving the first delimiting plate 16 away from the second delimiting plate 17 when the reversible clamping means assume the release configuration. Such guiding means 24 comprise a plurality of pins 25 arranged substantially vertically and distributed between the delimiting plates 16 and 17. Each pin 25 protrudes upward from the second delimiting plate 17 and is inserted with play into a corresponding hole defined in the first delimiting plate 16.

The guiding means 24 further comprise side clamps 26 for retaining the first delimiting plate 16, which are distributed along the peripheral region of the second delimiting plate 17.

Finally, the apparatus 1 can comprise actuation means 27 for alternately sliding the forming means 9 between the first and the second operating configuration.

In the embodiment shown, for example, such actuation means 27 comprise a worm screw 28 functionally associated with rotary actuation means 29 and a female thread 30 associated with the forming means 9, which are mutually engaged. The worm screw 28 has a longitudinal axis arranged substantially horizontal and is supported by the apparatus 1 above the supporting table 12. The actuation means 29 comprise a gear motor for rotationally actuating the worm screw 28 about its own longitudinal axis. The female thread 30 is associated with one end of the supporting table 12 and is engaged with the worm screw 28.

The possibility is not ruled out, however, that the actuation means can be structured differently and comprise, for example, pneumatic, hydraulic or electric actuators. Alternatively, the actuation means could be absent and the movement of the forming means 9 could be performed manually.

The supporting table 12 has, along an edge that is transverse to the movement direction M, a tooth 33 that abuts against the second delimiting plate 17 in the first operating configuration.

During the normal operation of the apparatus 1 the forming means 9 are kept in the first operating configuration, with the reversible clamping means 18 in the locked configuration.

If the need arises to intervene to inspect the die 10, for cleaning or replacement, it is sufficient to loosen the safety screws 31 and unscrew the threaded elements 19, extracting them from their seats, so that the springs 21 extend to support the weight of the first delimiting wall 16 with the intake chamber 2 above it. At this point, by actuating the actuation means 29 it is possible to make the worm screw 28 perform a rotation in a first direction so as to obtain the translation of the supporting table 12 with its die 11 from the first to the second operating configuration.

In this manner the die 11 can be freely accessed without needing to dismantle the intake chamber 2 and having to switch off the corresponding heating elements 5.

Once the intervention is complete the actuation means 29 is actuated again to make the worm screw 28 perform a rotation in a second direction, opposite to the first, so as to obtain the return of the supporting table 12 with its die 10 in the first operating configuration, and the safety screws 31 and the threaded elements 19 are tightened in order to allow the apparatus 1 to resume normal operation.

In practice it has been found that the apparatus according to the invention as described achieves the intended aim and objects and, in particular, attention is drawn to the fact that the apparatus according to the invention makes it possible to execute interventions to inspect, clean and replace the forming die in shorter times, without needing to switch off the heating elements that maintain the temperature of the mass of molten plastic material, at low cost and under optimal safety conditions.

These aspects also make it possible to increase the frequency with which such interventions are performed in order to keep high the efficiency levels of the production plant in which the apparatus according to the invention is inserted.

The apparatus thus conceived is susceptible of numerous modifications and variations, all of which are within the scope of the appended claims.

Moreover, all the details may be substituted by other, technically equivalent elements.

In practice the materials employed, as well as the contingent dimensions and shapes, may be any according to requirements without for this reason departing from the scope of protection claimed herein.

The disclosures in Italian Patent Application No. 102022000021948 from which this application claims priority are incorporated herein by reference.

1-13. (canceled)

14. An apparatus for degassing molten plastic material, comprising:
an intake chamber provided with an entry port and an exit port for molten plastic material,
an evacuation chamber for a gas present in the molten plastic material, provided with an entry opening and an exit opening for the molten plastic material, which is arranged downstream of said intake chamber along a flow direction of the molten plastic material with the entry opening associated in communication with the exit port of said intake chamber, and
forming means for the molten plastic material in transit through said evacuation chamber, which comprise at least one forming die,
wherein said forming means are associated so as to move with an alternating sliding motion along a movement direction transverse to said flow direction with respect to said intake chamber and said evacuation chamber, the forming means being configured to assume alternately a first operating configuration, in which the at least one die is associated in communication with said intake and evacuation chambers through the exit port of said intake chamber and the entry opening of said evacuation chamber, and a second operating configuration, in which the at least one die is accessible from outside said intake and evacuation chambers.

15. The apparatus according to claim 14, wherein said forming means comprise a supporting table for said at least one die which is interposed between said intake chamber and said evacuation chamber.

16. The apparatus according to claim 16, wherein said supporting table comprises at least one receptacle for said at least one die.

17. The apparatus according to claim 17, wherein said at least one receptacle comprises a perimeter raised portion which protrudes inside said receptacle, and wherein said at least one die comprises a perimeter edge configured to abut against said raised portion.

18. The apparatus according to claim 15, further comprising a first delimiting plate for said intake chamber associated with said exit opening and a second delimiting plate for said evacuation chamber associated with said entry opening, the supporting table being associated so as to slide between the delimiting plates.

19. The apparatus according to claim 18, further comprising reversible clamping means of said supporting table between said first and second delimiting plates, which are configured to assume alternately a configuration of locking the sliding of the supporting table with respect to the first and second delimiting plates and a configuration of releasing the sliding of the supporting table with respect to the first and second delimiting plates.

20. The apparatus according to claim 19, wherein said reversible clamping means comprise a plurality of threaded elements inserted so as to pass through said supporting table and said delimiting plates.

21. The apparatus according to claim 19, wherein said reversible clamping means comprise a plurality of safety screws interposed between said first and second delimiting plates.

22. The apparatus according to claim 19, further comprising elastic compression means interposed between said first and second delimiting plates for spacing said first and second delimiting plates apart when the reversible clamping means assume the release configuration.

23. The apparatus according to claim 19, further comprising guiding means for moving said first delimiting plate away from said second delimiting plate when the reversible clamping means assume the release configuration.

24. The apparatus according to claim 14, further comprising actuation means of the alternating sliding motion of said forming means between said first and said second operating configuration.

25. The apparatus according to claim 24, wherein said actuation means comprise a worm screw which is functionally associated with rotary actuation means and a female thread associated with said forming means, said worm screw and said female thread being mutually engaged.

26. The apparatus according to claim 14, wherein said flow direction is substantially vertical and said movement direction is substantially horizontal.
